(19) United States
(12) Patent Application Publication
(10) Pub. No.: US 2008/0214059 A1
(43) Pub. Date: Sep. 4, 2008

(54) Orthogonal electrical connector with increased contact density

(75) Inventors: Brent Ryan Rothermel, Harrisburg, PA (US); Michael Warren Fogg, Harrisburg, PA (US)

Correspondence Address: Robert J. Kapalka;Tyco Electronics Corporation, Suite 140, 4550 New Linden Hill Road, Wilmington, DE, 19808-2952, US

(73) Assignee: Tyco Electronics Corporation

(21) Appl. No.: 11/713,503

(22) Filed: Mar. 2, 2007

(51) Int. Cl. H01R 13/514

(52) U.S. Cl. 439/701

(57) ABSTRACT

An electrical connector includes a housing that holds signal contacts which are associated as signal contact pairs. The housing has a mounting face and the signal contact pairs are aligned in rows along the mounting face. Each of the rows includes multiple signal contact pairs. Each of the signal contact pairs includes two of the signal contacts aligned on a respective axis. The axes of the signal contact pairs within each row are aligned in a common direction, and the axes of the signal contact pairs in adjacent rows are aligned in respective different directions.

### BACKGROUND OF THE INVENTION

The invention relates generally to electrical connectors and, more particularly, to a connector that may be used in an orthogonal relationship with an identical connector on both sides of a midplane.

Some electrical systems, such as network switches and computer servers with switching capability, include connectors that are oriented orthogonally on opposite sides of a midplane in a cross connect application. Switch cards may be connected on one side of the midplane and line cards may be connected on the other side of the midplane. The line card and switch card are joined through connectors that are sometimes mounted on the midplane in an orthogonal relation to one another. The connectors include patterns of signal and ground contacts that extend through a pattern of vias in the midplane.

However, conventional orthogonal connectors have experienced certain limitations. For example, it is desirable to increase the density of the signal and ground contacts within the connectors. Heretofore, the contact density has been limited in orthogonal connectors, due to the contact and via patterns. Conventional contact and via patterns of an orthogonal connection are formed symmetric about a 45 degree axis with respect to columns or rows of the contacts. The symmetric arrangement limits the density of the signal and ground contacts in conventional orthogonal connectors. For example, in differential applications where signal contacts are arranged in a plurality of differential pairs, a distance, sometimes referred to as a pitch, between adjacent signal pairs has been determined based on a space needed for each differential pair and an associated ground(s). The pitch must be a square grid such that the row to row pitch is the same as the column to column pitch in order to use the same connector design on each side of the midplane, which may be desirable to reduce a cost and/or a complexity of the orthogonal connector.

A need remains for an improved orthogonal connector that increases contact and via density in differential pair applications.

### BRIEF DESCRIPTION OF THE INVENTION

In one aspect, an electrical connector is provided that includes a housing that holds signal contacts which are associated as signal contact pairs. The housing has a mounting face and the signal contact pairs are aligned in rows along the mounting face. Each of the rows includes multiple signal contact pairs. Each of the signal contact pairs includes two of the signal contacts aligned on a respective axis. The axes of the signal contact pairs within each row are aligned in a common direction, and the axes of the signal contact pairs in adjacent rows are aligned in respective different directions.

In another aspect, an electrical connector assembly including a pair of connectors configured to be electrically connected to one another from opposite sides of a circuit board is provided. The electrical connector assembly includes first and second connector housings. Each connector housing has a mating face and a mounting face. The mounting faces are configured to be electrically connected to one another from opposite sides of the circuit board approximately in line with one another along a longitudinal axis such that the connector housings are angularly offset ninety degrees about the longitudinal axis with respect to one another. Signal and ground contacts are held in the first and second connector housings. The signal contacts are arranged in differential pairs to form signal contact pairs. The ground contacts and the signal contact pairs are aligned in a pattern of rows and columns. Each of the rows includes ground contacts and a first group of the signal contact pairs arranged along a row axis. Adjacent rows are separated by a predetermined row pitch and have interstitial spaces located therebetween. The signal contacts further include a second group of the signal contact pairs located in the interstitial spaces between the adjacent rows and offset from the adjacent rows by a distance less than the row pitch.

In another aspect, an electrical connector includes a housing that holds signal contacts which are associated as signal contact pairs. The housing has a mounting face and the signal contact pairs are aligned in rows along the mounting face. Each of the rows includes multiple signal contact pairs. Each of the signal contact pairs includes two signal contacts aligned on a respective axis. A first signal contact pair includes first and second signal contacts and a second signal contact pair includes third and fourth signal contacts. The second signal contact pair is adjacent the first signal contact pair. The first signal contact is located generally the same distance from both the third and fourth signal contacts. The second signal contact is located generally the same distance from both the third and fourth signal contacts.

In another aspect, an electrical connector assembly includes a pair of connectors configured to be electrically connected to one another from opposite sides of a circuit board. The electrical connector assembly includes first and second connector housings each having a mating face and a mounting face. The mounting faces are configured to be electrically connected to one another from opposite sides of the circuit board approximately in line with one another along a longitudinal axis such that the first and second connector housings are angularly offset ninety degrees about the longitudinal axis with respect to one another. Signal and ground contacts are held in the first and second connector housings. The signal contacts are arranged in differential pairs to form a first group of signal contact pairs and a second group of signal contact pairs. The ground contacts and the first group of signal contact pairs are aligned in a first pattern of first rows and first columns, wherein the first group of signal contact pairs are arranged along first row and first column axes, adjacent first rows are separated by a predetermined first row pitch, and adjacent columns are separated by a predetermined first column pitch. The first column pitch is substantially equal to the first row pitch. The second group of signal contact pairs is arranged in a second pattern of second rows and second columns. The second group of signal contact pairs are arranged along second row and second column axes, wherein adjacent second rows are separated by a predetermined second row pitch, and adjacent second columns are separated by a predetermined second column pitch. The second row pitch and the second column pitch of the second group of signal contact pairs is substantially equal to the first row pitch and the first column pitch, respectively, of the first group of signal contact pairs. Each second row of the second group of signal contact pairs is offset from adjacent first rows of the first group of signal contact pairs by less than one first row pitch. Each second column of the second group of signal contact pairs is offset from adjacent first columns of the first group of signal contact pairs by less than one first column pitch.

### BRIEF DESCRIPTION OF THE DRAWINGS

FIG. 1 is a perspective view of an exemplary orthogonal connector assembly formed in accordance with an embodiment of the present invention.

FIG. 2 is a perspective view one of the receptacle connectors shown in FIG. 1 formed in accordance with an embodiment of the present invention.

FIG. 3 is a perspective view of one of the header connectors shown in FIG. 1 formed in accordance with an embodiment of the present invention.

FIG. 4 is a schematic diagram of an exemplary pattern of signal and ground contact vias formed in accordance with the embodiment of the present invention shown in FIG. 3.

FIG. 5 is a bottom plan view of the header connector shown in FIG. 3 formed in accordance with the embodiment of the present invention shown in FIGS. 3 and 4.

FIG. 6 is a top plan view of the header connector shown in FIG. 3 formed in accordance with the embodiment of the present invention shown in FIGS. 3-5.

FIG. 7 is a schematic diagram of an exemplary pattern of signal and ground contact vias formed in accordance with an alternative embodiment of the present invention.

FIG. 8 is a schematic diagram of an exemplary pattern of signal and ground contact vias formed in accordance with another alternative embodiment of the present invention.

FIG. 9 is a bottom plan view of a header connector formed in accordance with the embodiment of the present invention shown in FIG. 8.

### DETAILED DESCRIPTION OF THE INVENTION

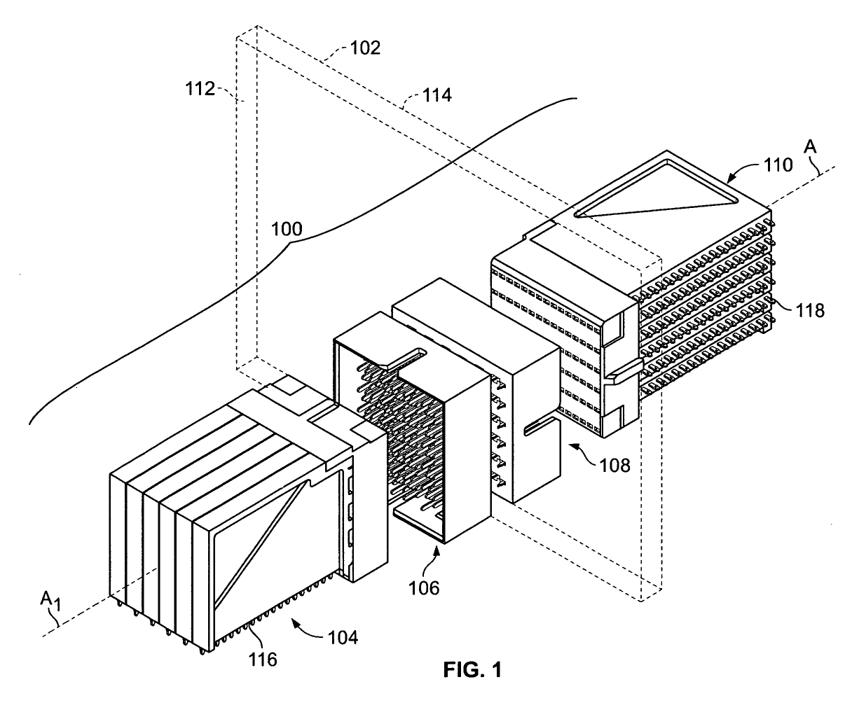

FIG. 1 is a perspective view of an orthogonal connector assembly 100 formed in accordance with an embodiment of the present invention. The connector assembly 100 is mounted on a midplane circuit board 102, which is shown in phantom lines for clarity. The connector assembly 100 includes a receptacle connector 104, a header connector 106, a header connector 108, and a receptacle connector 110. The header and receptacle connectors 106 and 104, respectively, are mounted on a first side 112 of the midplane 102 and connect through the midplane 102 to the header and receptacle connectors 108 and 110, respectively, which are mounted on a second side 114 of the midplane 102.

The receptacle connector 104 includes a daughter card interface 116. By way of example only, the receptacle connector 104 may be mounted on a line card (not shown) at the interface 116. Similarly, the receptacle connector 110 includes a daughter card interface 118 and, by way of example only, the receptacle connector 1 10 may be mounted on a switch card (not shown) at the interface 118. The connector assembly 100 includes a longitudinal axis A₁ that extends from the receptacle connector 104 through the receptacle connector 110. The receptacle connectors 104 and 1 0 are identical to one another. Also, the headers connectors 106 and 108 are identical to one another.

The header connectors 106 and 108 are oriented such that the header connectors 106 and 108 are rotated ninety degrees with respect to one another to form an orthogonal connection therebetween. The receptacle connectors 104 and 110 are likewise rotated ninety degrees with respect to one another.

Although the embodiments will be described in terms of a connector assembly 100 as illustrated in FIG. 1, it is to be understood the benefits herein described are also applicable to connector systems wherein a receptacle connector is mounted on a midplane circuit board or some other type of board or structure.

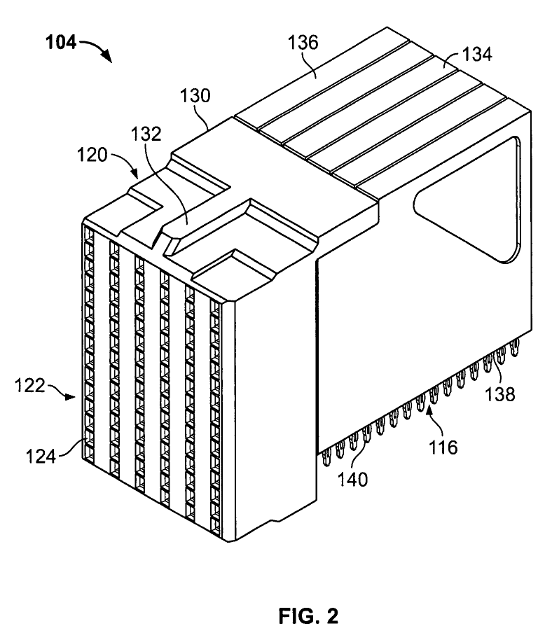

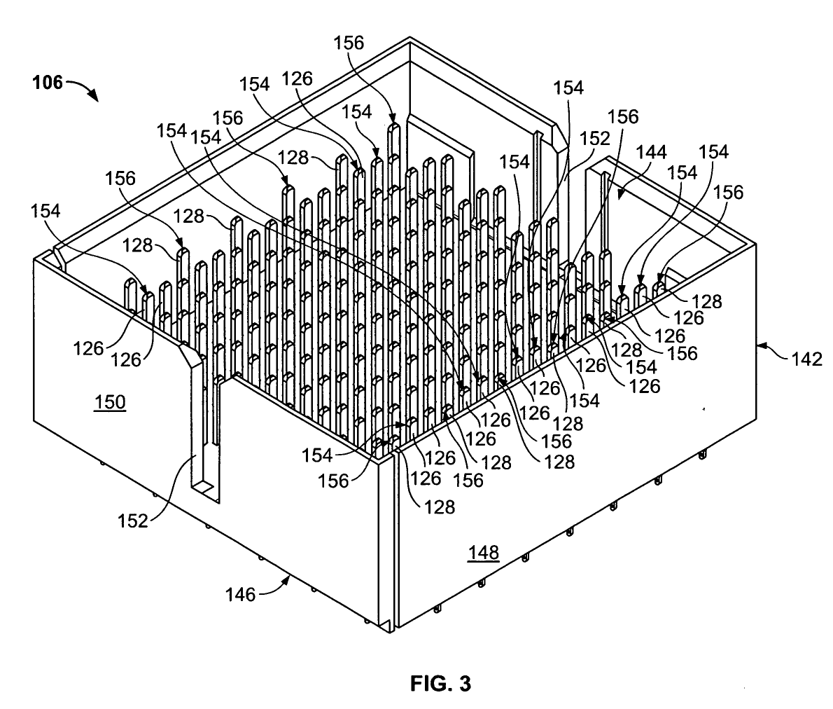

FIG. 2 is a perspective view of the receptacle connector 104 formed in accordance with an embodiment of the present invention. The receptacle connector 104 includes a dielectric housing 120 that has a mating face 122 having a plurality of contact channels 124. The contact channels 124 are configured to receive mating contacts 126 and 128 (see FIG. 3) from a mating header connector such as, but not limited to, the header connector 106 (FIG. 1). The receptacle connector 104 also includes an upper shroud 130 that extends rearwardly from the mating face 122. Guide ribs 132 are formed on opposite sides of the housing 120 to orient the receptacle connector 104 for mating with the header connector 106. The housing 120 receives a plurality of contact modules 134 holding contacts and conductive paths that connect the daughter card interface 116 with the mating face 122. In an exemplary embodiment, the interface 116 is substantially perpendicular to the mating face 122 such that the receptacle connector 104 interconnects electrical components that are substantially at a right angle to each other.

Each contact module 134 includes a contact lead frame (not shown) that is overmolded and encased in a contact module housing 136 fabricated from a dielectric material. The housing 136 has a forward mating end (not shown) that is received in the receptacle connector housing 120 and a mounting edge 138 configured for mounting to a circuit board (not shown) or some other type of board or structure. Contact tails 140 extend from the lead frame within the contact module 134 and extend through the mounting edge 138 of the contact module 134 for attachment to the circuit board or other type of board or structure.

FIG. 3 is a perspective view of the header connector 106 formed in accordance with an embodiment of the present invention. The header connector 106 includes a dielectric housing 142 having a mating end 144 that receives the receptacle connector 104 (FIG. 2) and a mounting end 146 for mounting the header connector 106 to the midplane 102 (FIG. 1). The housing 142 includes pairs of opposed shrouds 148 and 150 that surround the mating end 144. Guide slots 152 are provided on two opposed shrouds 150 that receive the guide ribs 132 (FIG. 2) on the receptacle connector 104 to orient the receptacle connector 104 with respect to the header connector 106. The header connector 106 holds a plurality of electrical contacts, some of which are signal contacts 126 and others of which are ground contacts 128. Although the signal and ground contacts 126 and 128, respectively, may be mounted in the header connector housing 142 using any suitable method, means, and/or structure, the signal and ground contacts 126 and 128, respectively, may be configured, for example, for press fit installation in the housing 142.

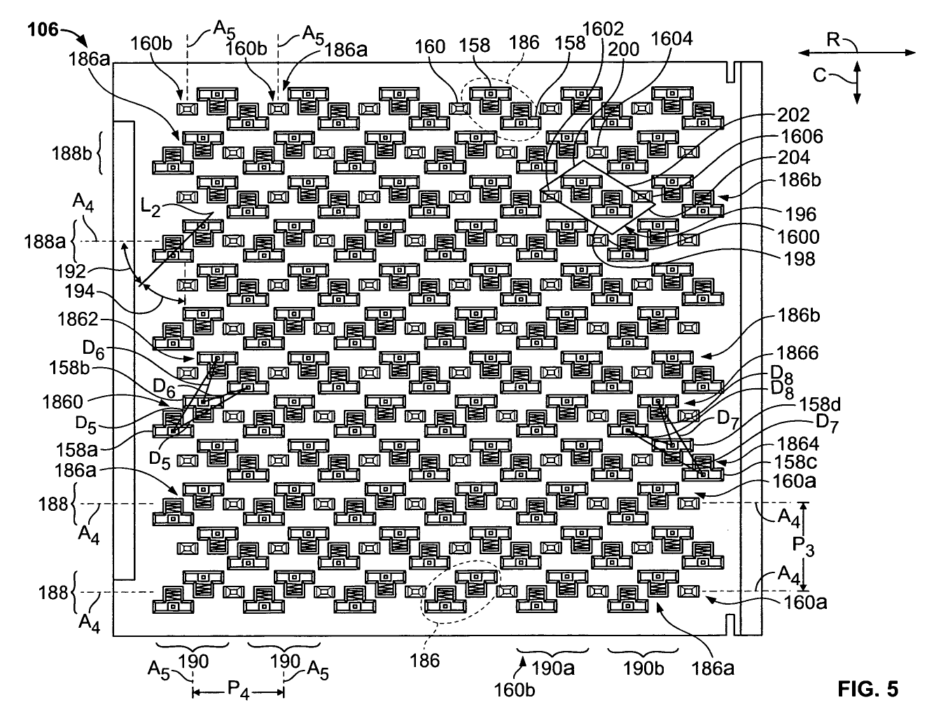

The ground contacts 128 may be longer than the signal contacts 126 so that the ground contacts 128 are the first to mate and last to break when the header connector 106 is mated and separated, respectively, with the receptacle connector 104. The signal contacts 126 are arranged in pairs that each carry signals in a differential pair. The signal and ground contacts 126 and 128 each include a mating end 154 and 156 and an opposite mounting end 158 and 160 (FIG. 5), respectively. The signal and ground contacts 126 and 128, respectively, are arranged in a predetermined pattern of rows and columns, as will be described in more detail below. The pattern of the header connector mating end 144 is identical to a contact and lead frame pattern (not shown) of the contact modules 134 (FIG. 2). The ground contact mating ends 156 are each configured, for example sized and shaped, to be matable with a ground contact (not shown) in the receptacle connector 104. Similarly, the signal contact mating ends 154 are each configured, for example sized and shaped, to be matable with a signal contact in the receptacle connector 104.

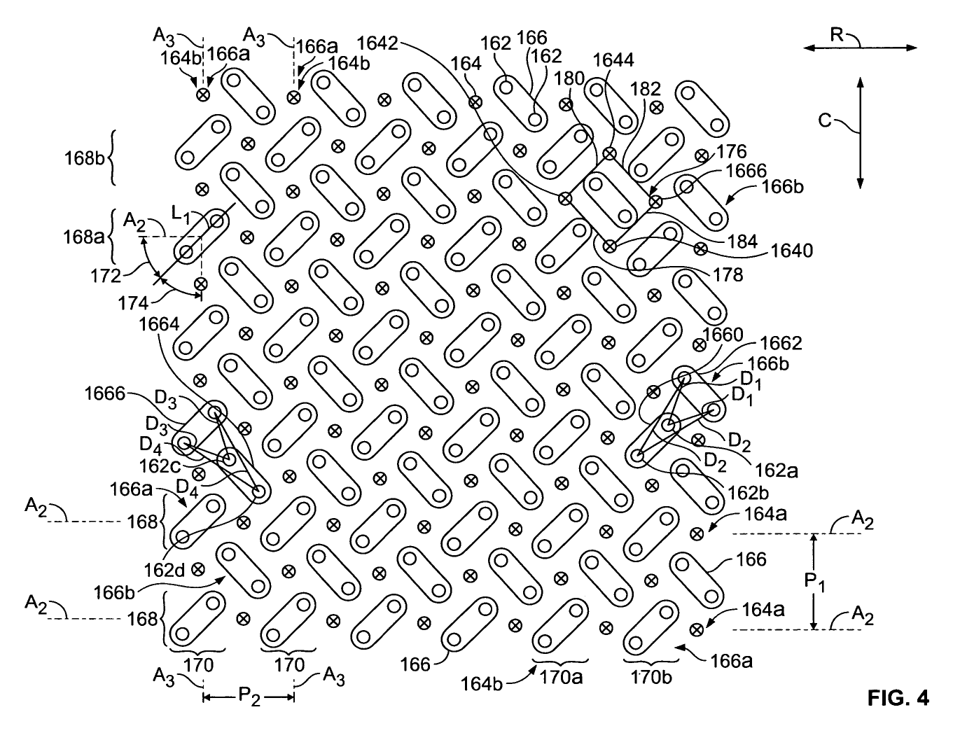

The signal and ground contact mounting ends 158 and 160, respectively, facilitate mounting the header connector 106 to a circuit board or some other type of board or structure, such as, but not limited to, the midplane 102 (FIG. 1). The signal and ground contacts 126 and 128, respectively, are configured to be mounted in respective through vias 162 and 164 (FIG. 4) in the midplane 102 when the header connector 106 is mounted on the first side (FIG. 1) of the midplane 102. In addition, the header connector 106 is configured to be mounted in an orthogonal relationship with the identical header connector 108 on the second side 114 of the midplane 102. That is, when the header connectors 106 and 108 are angularly offset from each other by ninety degrees about the longitudinal axis A₁ (FIG. 1), the mounting end 158 of each signal contact 126 in the header connector 106 is positioned to be received in a via 162 that is shared by the mounting end 158 of another signal contact 126 in the header connector 108. That is, the mounting ends 158 of corresponding signal contacts 126 extend into opposite ends of the same via 162. Similar to the signal contacts 126, the header connector 106 and the identical header connector 108 may be configured such that the ground contacts 128 of the header connector 106 are also received in common through vias 164 with the ground contacts of the header connector 108. Alternatively, the ground contacts 128 do not share vias in the midplane 102 when the header connectors 106 and 108 are mounted thereon, but rather the ground contacts 128 may be configured to electrically engage at least one ground plane (not shown) in the midplane 102. The ground planes provide continuity between the ground contacts 128 in the header connector 106 from the first side 112 side of the midplane 102 to the ground contacts 128 in the header connector 108 on the second side 114 of the midplane 102.

FIG. 4 is a schematic diagram of an exemplary pattern of signal and ground vias 162 and 164, respectively, formed in accordance with the embodiment of FIG. 3. The vias 162 and 164 of the respective signal and ground contacts 126 and 128 are arranged in a pattern wherein a group 166a of pairs 166 of the signal contact vias 162 are aligned in a plurality of rows 168, which extend in the direction of the arrow R, and a plurality of columns 170, which extend in the direction of the arrow C. Within each row 168, adjacent pairs 166 of the signal contact vias 162 are separated by individual ground contact vias 164 from a group 164a. Within each column 170, adjacent pairs 166 of the group 166a of the signal contact vias 162 are separated by individual ground contact vias 164 from a group 164b. Each ground contact via 164 of the group 164a is located between a pair of adjacent columns 170, and each ground contact via 164 of the group 164b is located between a pair of adjacent rows 168.

Each of the ground contact vias 164 of the group 164a within each row 168 is located on a corresponding row axis A₂. Further, each ground contact via 164 of the group 164b within each column 170 is located on a corresponding column axis A₃. In contrast to the ground contact vias 164, each of the signal contact vias 162 of the group 166a within each row 168 is offset from the ground contact vias 164 of the corresponding row 168 such that the signal contact vias 162 of each pair 166 within the corresponding row 168 are not located on the corresponding row axis A₂, but rather are arranged in a staggered pattern on respective opposite sides of the corresponding row axis A₂. Similarly, each of the signal contact vias 162 of the group 166a within each column 170 is offset from the ground contact vias 164 of the corresponding column 170 such that the signal contact vias 162 of each pair 166 within the corresponding column 170 are not located on the corresponding column axis A₃, but rather are arranged in a staggered pattern on respective opposite sides of the corresponding column axis A₃. The signal contact vias 162 of each pair 166 of the group 166a each define a line L₁ that intersects both of the corresponding row and column axes A₂ and A₃, respectively, at an angle 172 and 174, respectively. The angles 172 and 174 may each be any suitable angle that enables the signal contact vias 162 to function as described herein. For example, as shown in FIG. 4 the angles 172 and 174 are each about 45°. Although shown as equal in FIG. 4, the angles 172 and 174 may be different from one another.

Alternatively, the signal contact vias 162 of each pair 166 of the group 166a within each row 168 and within each column 170 may not be arranged in a staggered pattern on respective opposite sides of the corresponding row and column axes A₂ and A₃, respectively, but rather may be located on the corresponding row and column axes A₂ and A₃.

Each row 168 is spaced apart by a predetermined row pitch P₁, which is defined as a distance between adjacent row axes A₂. Similarly, each column 170 is spaced apart by a predetermined column pitch P₂, which is defined as a distance between adjacent column axes A₃. Interstitial spaces 176 are located between adjacent rows 168 and adjacent columns 170. More specifically, each interstitial space 176 is defined as the space bounded by a line 178 extending from a ground contact via 164 of the group 164a (e.g., a via 1640) located within a row 168 (e.g., a row 168a) to an adjacent ground contact via 164 of the group 164b (e.g., a via 1642) located within a column 170 (e.g., a column 170a) that is adjacent the ground contact via 1640. Each interstitial space 176 is further bounded by a line 180 extending from the ground contact via 1642 within the column 170a to an adjacent ground contact via 164 of the group 164a (e.g., a via 1644) located within a row 168 (e.g., a row 168b) that is adjacent the ground contact via 1642, and a line 182 extending from the ground contact via 1644 within the row 168b to an adjacent ground contact via 164 of the group 164b (e.g., a via 1646) located within a column 170 (e.g., a column 170b) that is adjacent the ground contact vias 1640 and 1644. Each interstitial space 176 is further bounded by a line 184 extending from the ground contact via 1646 located within the column 170b to the ground contact via 1640 located within the row 168a.

Another group 166b of the signal contact via pairs 166 is located in the interstitial spaces 176 between adjacent rows 168 of the group 166a of the signal contact via pairs 166 and between adjacent columns 170 of the group 166a of the signal contact via pairs 166. More specifically, each interstitial space 176 includes only a single pair 166 of the group 166b of the signal contact vias 162. Each pair 166 of the group 166b of the signal contact vias 162 is offset from adjacent rows 168 by a distance that is less than the row pitch P₁ and is offset from adjacent columns 170 by a distance that is less than the column pitch P₂. Each pair 166 of the group 166b of the signal contact vias 162 is orientated about orthogonally to each pair 166 of the group 166a of the signal contact vias 162.

Each signal contact via pair 166 of the group 166a is adjacent at least one signal contact via pair 166 of the group 166b. Similarly, each signal contact via pair 166 of the group 166b is adjacent at least one signal contact via pair 166 of the group 166a. In the embodiment shown in FIG. 4, and with regard to two adjacent signal contact via pairs 166 where one pair is of the group 166a and the other pair is of the group 166b, a first signal contact via 162 of a first of the adjacent pairs 166 is located the same distance from both the signal contact vias 162 of the other, or second, pair 166. Similarly, the second signal contact via 162 of the first signal contact via pair 166 is located the same distance from both signal contact vias 162 of the second pair 166. Depending upon the orientation of the two adjacent pairs 166 relative to each other, the first pair 166 may be of the group 166a or the group 166b. For example, a first signal contact via pair 1660 of the group 166a includes signal contact vias 162a and 162b. The signal contact via 162a is located the same distance D₁ from both of the signal contact vias 162 of the second signal contact via pair 1662 of the group 166b that is adjacent the first signal contact pair 1660 of the group 166a. Similarly, the signal contact via 162b is located the same distance D₂ from both of the signal contact vias 162 of the second signal contact via pair 1662. Moreover, and for example, a first signal contact via pair 1664 of the group 166b includes signal contact vias 162c and 162d. The signal contact via 162c is located the same distance D₃ from both of the signal contact vias 162 of a second signal contact via pair 1666 of the group 166a that is adjacent the first signal contact pair 1664 of the group 166b. Similarly, the signal contact via 162d is located the same distance D₄ from both of the signal contact vias 162 of the second signal contact via pair 1666.

FIG. 5 is a bottom plan view of the header connector 106 formed in accordance with the embodiment of the present invention shown in FIGS. 3 and 4. The mounting ends 158 and 160 of the respective signal and ground contacts 126 and 128 are arranged in a pattern wherein a group 186a of pairs 186 of the signal contact mounting ends 158 are aligned in a plurality of rows 188, which extend in the direction of the arrow R, and a plurality of columns 190, which extend in the direction of the arrow C. Within each row 188, adjacent pairs 186 of the signal contact mounting ends 158 are separated by individual ground contact mounting ends 160 from a group 160a. Within each column 190, adjacent pairs 186 of the group 186a of the signal contact mounting ends 158 are separated by individual ground contact mounting ends 160 from another group 160b. Each of the ground contact mounting ends 160 of the group 160a is located between a pair of adjacent columns 190, and each ground contact mounting end 160 of the group 160b is located between a pair of adjacent rows 188.

Each of the ground contact mounting ends 160 of the group 160a within each row 188 is located on a corresponding row axis A₄. Further, each ground contact mounting end 160 of the group 160b within each column 190 is located on a corresponding column axis A₅. In contrast to the ground contact mounting ends 160, each of the signal contact mounting ends 158 of the group 186a within each row 188 is offset from the ground contact mounting ends 160 of the corresponding row 188 such that the signal contact mounting ends 158 of each pair 186 within the corresponding row 188 are not located on the corresponding row axis A₄, but rather are arranged in a staggered pattern on respective opposite sides of the corresponding row axis A₄. Similarly, each of the signal contact mounting ends 158 of the group 186a within the each column 190 is offset from the ground contact mounting ends 160 of the corresponding column 190 such that the signal contact mounting ends 158 of each pair 186 within the corresponding column 190 are not located on the corresponding column axis A₅, but rather are arranged in a staggered pattern on respective opposite sides of the corresponding column axis A₅. The signal contact mounting ends 158 of each pair 186 of the group 186a each define a line L₂ that intersects both of the corresponding row and column axes A₄ and A₅, respectively, at an angle 192 and 194, respectively. The angles 192 and 194 may each be any suitable angle that enables the signal contact mounting ends 158 to function as described herein. For example, as shown in FIG. 5 the angles 192 and 194 are each about 45°. Although shown as equal in FIG. 5, the angles 192 and 194 may be different from one another.

Alternatively, the signal contact mounting ends 158 of each pair 186 of the group 186a within each row 188 and within each column 190 may not be arranged in a staggered pattern on respective opposite sides of the corresponding row and column axes A₄ and A₅, respectively, but rather may be located on the corresponding row and column axes A₄ and A₅.

Each row 188 is spaced apart by a predetermined row pitch P₃, which is defined as a distance between each adjacent pair of row axes A₄. Similarly, each column 190 is spaced apart by a predetermined column pitch P₄, which is defined as a distance between each adjacent pair of column axes A₅. Interstitial spaces 196 are located between adjacent rows 188 and adjacent columns 190. More specifically, each interstitial space 196 is defined as the space bounded by a line 198 extending from a ground contact mounting end 160 of the group 160a (e.g., an end 1600) located within a row 188 (e.g., a row 188a), to an adjacent ground contact mounting end 160 of the group 160b (e.g., an end 1602) located within a column 190 (e.g., a column 190a) that is adjacent the ground contact mounting end 1600. Each interstitial space 196 is further bounded by a line 200 extending from the ground contact mounting end 1602 within the column 190a to an adjacent ground contact mounting end 160 of the group 160a (e.g., an end 1604) located within a row 188 (e.g., a row 188b) that is adjacent the ground contact mounting end 1602, and a line 202 extending from the ground contact mounting end 1604 within the row 188b to an adjacent ground contact mounting end 160 of the group 160b (e.g., an end 1606) located within a column 190 (e.g., a column 190b) that is adjacent the ground contact mounting end 1604. Each interstitial space 196 is further bounded by a line 204 extending from the ground contact mounting end 1606 located within the column 190b to the ground contact mounting end 1600 located within the row 188a.

Another group 186b of the signal contact mounting ends 158 is located in the interstitial spaces 196 between adjacent rows 188 of the group 186a of the signal contact mounting end pairs 186 and between adjacent columns 190 of the group 186a of the signal contact mounting end pairs 186. More specifically, each interstitial space 196 includes only a single pair 186 of the group 186b of the signal contact mounting ends 158. Each pair 186 of the group 186b of the signal contact mounting ends 158 is offset from adjacent rows 188 by a distance that is less than the row pitch P₃ and is offset from adjacent columns 190 by a distance that is less than the column pitch P₄. Each pair 186 of the group 186b is orientated about orthogonally to each pair 186 of the group 186a of the signal contact mounting ends 158.

Each signal contact mounting end pair 186 of the group 186a is adjacent at least one signal contact mounting end pair 186 of the group 186b. Similarly, each signal contact mounting end pair 186 of the group 186b is adjacent at least one signal contact mounting end pair 186 of the group 186a. In the embodiment shown in FIG. 5, and with regard to two adjacent signal contact mounting pairs 186 where one pair is of the group 186a and the other pair is of the group 186b, a first signal contact mounting end 158 of a first of the adjacent pairs 186 is located the same distance from both the signal contact mounting ends 158 of the other, or second, pair 186. Similarly, the second signal contact mounting end 158 of the first signal contact mounting end pair 186 is located the same distance from both signal contact mounting ends 158 of the second pair 186. Depending upon the orientation of the two adjacent pairs 186 relative to each other, the first pair 186 may be of the group 186a or the group 186b. For example, a first signal contact mounting end pair 1860 of the group 186a includes signal contact mounting ends 158a and 158b. The signal contact mounting end 158a is located the same distance D₅ from both of the signal contact mounting ends 158 of a second signal contact mounting end pair 1862 of the group 186b that is adjacent the first signal contact mounting end pair 1860 of the group 186a. Similarly, the signal contact mounting end 158b is located the same distance D₆ from both of the signal contact mounting ends 158 of the second signal contact mounting end pair 1862. Moreover, and for example, a first signal contact mounting end pair 1864 of the group 186b includes signal contact mounting ends 158c and 158d. The signal contact mounting end 158c is located the same distance D₇ from both of the signal contact mounting ends 158 of a second signal contact mounting end pair 1866 of the group 186a that is adjacent the first signal contact mounting end pair 1864 of the group 186b. Similarly, the signal contact mounting end 158d is located the same distance D₈ from both of the signal contact mounting ends 158 of the second signal contact mounting end pair 1866.

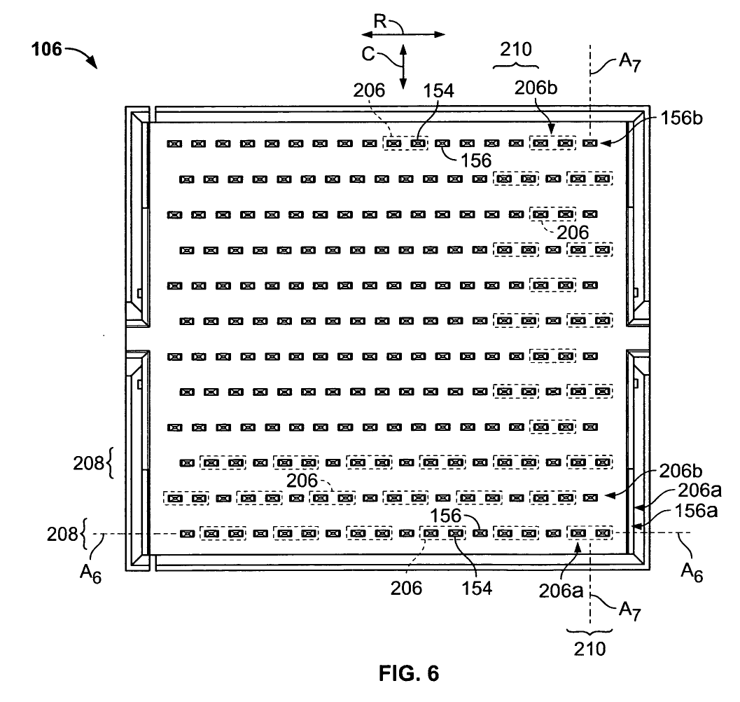

FIG. 6 is a top plan view of the header connector 106 formed in accordance with the embodiment of the present invention shown in FIGS. 3-5. The mating ends 154 and 156 of the respective signal and ground contacts 126 and 128 are arranged in a pattern wherein a group 206a of pairs 206 of the signal contact mating ends 154 are aligned in a plurality of rows 208, which extend in the direction of the arrow R, and a plurality of columns 210, which extend in the direction of the arrow C. Within each row 208, pairs 206 of the group 206a of the signal contact mating ends 154 are separated by individual ground contact mating ends 156 from a group 156a. Within each column 210, the pairs 206 of the group 206a of the signal contact mating ends 154 are separated by individual ground contact mating ends 156 from another group 156b. Each ground contact mating end 156 of the group 156b is located between a pair of adjacent columns 210. Similarly, each ground contact mating end 156 of the group 156a is located between a pair of adjacent rows 208.

The respective signal and ground contact mating ends 154 and 156 within each row 208 are located on a corresponding row axis A₆. Further, each of the group 156b of the ground contact mating ends 156 within each column 210 are located on a corresponding column axis A₇. However, each of the group 206a of the signal contact mating ends 154 within each column 208 is offset from the group 156b of the ground contact mating ends 156 such that each of the signal contact mating ends 154 within each column 210 are not located on the corresponding column axis A₇, but rather are arranged in a staggered pattern on respective opposite sides of the corresponding column axis A₇. Pairs 206 of a second group 206b of the signal contact mating ends 154 are located between each adjacent row 208 and between each adjacent column 210 of the group 206a of the signal contact mating ends 154. Alternatively, each of the signal contact mating ends 154 of the group 206a within each column 210 may not be arranged in a staggered pattern on respective opposite sides of the corresponding column axis A₇, but rather may be located on the corresponding column axis A₇.

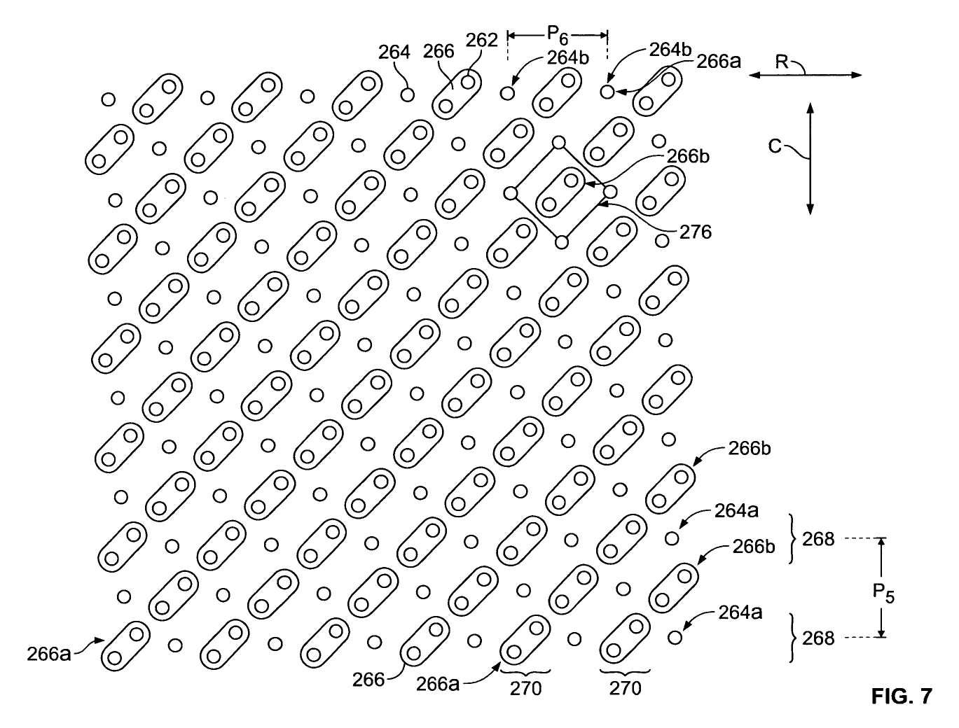

FIG. 7 is a schematic diagram of an exemplary pattern of signal and ground contact vias 262 and 264, respectively, formed in accordance with an alternative embodiment of the present invention. Similar to the embodiment shown in FIG. 4, the signal and ground contact vias 262 and 264 are arranged in a pattern wherein a group 266a of pairs 266 of the signal contact vias 262 are aligned in a plurality of rows 268, which extend in the direction of the arrow R, and a plurality of columns 270, which extend in the direction of the arrow C. Within each row 268, adjacent pairs 266 of the signal contact vias 262 are separated by individual ground contact vias 264 from a group 264a. Within each column 270, adjacent pairs 266 of the group 266a of the signal contact vias 262 are separated by individual ground contact vias 264 from a group 264b. Interstitial spaces 276 are located between adjacent rows 268 and adjacent columns 270. Another group 266b of the signal contact via pairs 266 is located in the interstitial spaces 276 between adjacent rows 268 of the group 266a of the signal contact via pairs 266 and between adjacent columns 270 of the group 266a of the signal contact via pairs 266. More specifically, each interstitial space 276 includes only a single pair 266 of the group 266b of the signal contact vias 262. Each pair 266 of the group 266b of the signal contact vias 262 is offset from adjacent rows 268 by a distance that is less than a row pitch P₅ and is offset from adjacent columns 270 by a distance that is less than the column pitch P₆. In contrast to the embodiment shown in FIG. 4, each pair 266 of the group 266b of the signal contact vias 262 is orientated about parallel to each pair 266 of the group 266a of the signal contact vias 262. Alternatively, some or all of the pairs 266 of the group 266b of the signal contact vias 262 may be orientated at any other suitable angle to one or more pairs 266 of the group 266b.

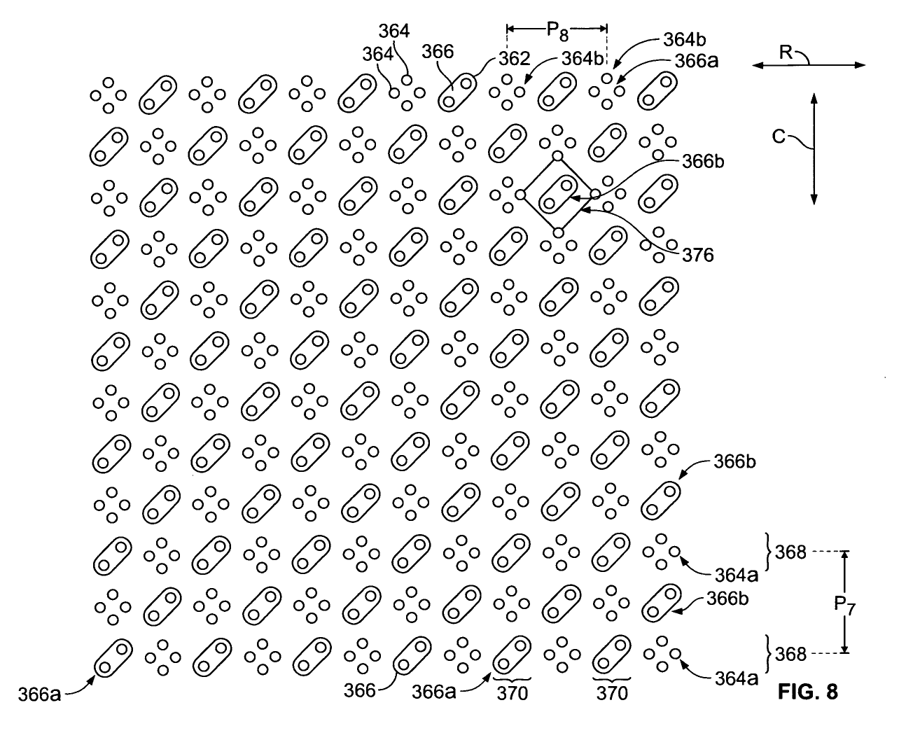

FIG. 8 is a schematic diagram of an exemplary pattern of signal and ground contact vias 362 and 364, respectively, formed in accordance with another alternative embodiment of the present invention. Similar to the embodiments shown in FIGS. 4 and 7, the signal and ground contact vias 362 and 364 are arranged in a pattern wherein a group 366a of pairs 366 of the signal contact vias 362 are aligned in a plurality of rows 368, which extend in the direction of the arrow R, and a plurality of columns 370, which extend in the direction of the arrow C. However, in contrast to the embodiments shown in FIGS. 4 and 7, adjacent pairs 366 of the signal contact vias 362 within each row 368 are separated by a plurality of ground contact vias 364 from a group 364a. Similarly, adjacent pairs 366 of the group 366a of the signal contact vias 362 within each column 370 are separated by a plurality of ground contact vias 364 from a group 364b. Although each row 368 and each column 370 are shown as being separated by two ground contact vias 364 in FIG. 8, each row 368 and each column 370 may be separated by any number of ground contact vias 364.

Interstitial spaces 376 are located between adjacent rows 368 and adjacent columns 370. Another group 366b of the signal contact via pairs 366 is located in the interstitial spaces 376 between adjacent rows 368 of the group 366a of the signal contact via pairs 366 and between adjacent columns 370 of the group 366a of the signal contact via pairs 366. More specifically, each interstitial space 376 includes only a single pair 366 of the group 366b of the signal contact vias 362. Each pair 366 of the group 366b of the signal contact vias 362 is offset from adjacent rows 368 by a distance that is less than a row pitch P₇ and is offset from adjacent columns 370 by a distance that is less than the column pitch P₈. Similar to the embodiment shown in FIG. 7, each pair 366 of the group 366b of the signal contact vias 362 is orientated about parallel to each pair 366 of the group 366a of the signal contact vias 362. Alternatively, some or all of the pairs 366 of the group 366b of the signal contact vias 362 may be orientated at any other suitable angle to one or more pairs 366 of the group 366b.

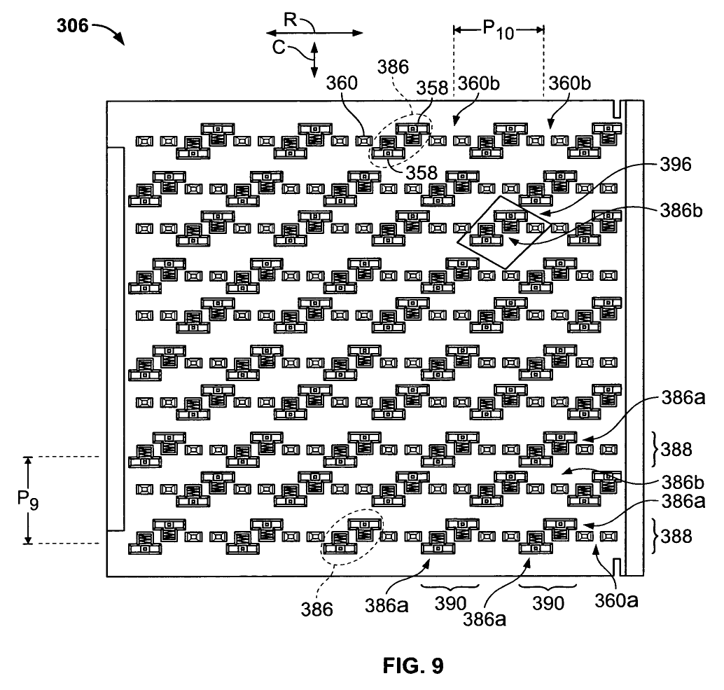

FIG. 9 is a bottom plan view of a header connector 306 formed in accordance with the embodiment shown in FIG. 8. Signal and ground contact mounting ends 358 and 360, respectively, are arranged in a pattern wherein a group 386a of pairs 386 of the signal contact mounting ends 358 are aligned in a plurality of rows 388, which extend in the direction of the arrow R, and a plurality of columns 390, which extend in the direction of the arrow C. Within each row 388, adjacent pairs 386 of the signal contact mounting ends 358 are separated by a plurality of ground contact mounting ends 360 from a group 360a. Similarly, within each column 390, adjacent pairs 386 of the group 386a of the signal contact mounting ends 358 are separated by a plurality of ground contact mounting ends 360 from another group 360b. Although each row 388 and each column 390 are shown as being separated by two ground contact mounting ends 360 in FIG. 9, each row 388 and each column 390 may be separated by any number of ground contact mounting ends 360.

Interstitial spaces 396 are located between adjacent rows 388 and adjacent columns 390. Another group 386b of the signal contact mounting ends 358 is located in the interstitial spaces 396 between adjacent rows 388 of the group 386a of the signal contact mounting end pairs 386 and between adjacent columns 390 of the group 386a of the signal contact mounting end pairs 386. More specifically, each interstitial space 396 includes only a single pair 386 of the group 386b of the signal contact mounting ends 358. Each pair 386 of the group 386b of the signal contact mounting ends 358 is offset from adjacent rows 388 by a distance that is less than a row pitch P₉ and is offset from adjacent columns 390 by a distance that is less than a column pitch P₁₀. Each pair 386 of the group 386b is orientated about parallel to each pair 386 of the group 386a of the signal contact mounting ends 358. Alternatively, some or all of the pairs 386 of the group 386b of the signal contact mounting ends 358 may be orientated at any other suitable angle to one or more pairs 386 of the group 386b.

The embodiments described herein provide a connector that may be used with an identical connector in an orthogonal relationship on both sides of a midplane. Ground contacts and a first group of differential pairs of signal contacts are aligned in a plurality of rows and columns in the connector. Interstitial spaces are defined between adjacent rows and adjacent columns. A second group of differential pairs of signal contacts are located in the interstitial spaces, which increases a density of contacts within the connector. The use of the same connector reduces connector costs and may reduce interference, or cross-talk, between adjacent signal contact pairs.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

While the invention has been described in terms of various specific embodiments, those skilled in the art will recognize that the invention can be practiced with modification within the spirit and scope of the claims.

What is claimed is:

1. An electrical connector comprising:
a housing that holds signal contacts which are associated as signal contact pairs, the housing having a mounting face and the signal contact pairs being aligned in rows along the mounting face, each of the rows including multiple said signal contact pairs, each of the signal contact pairs including two of said signal contacts aligned on a respective axis;
wherein the axes of the signal contact pairs within each said row are aligned in a common direction; and
wherein the axes of the signal contact pairs in adjacent said rows are aligned in respective different directions.

2. The electrical connector of claim 1, wherein the respective different direction are orthogonal to each other.

3. The electrical connector of claim 1, wherein each of the rows includes ground contacts disposed alternatively between adjacent signal contact pairs.

4. The electrical connector of claim 1, wherein the signal contact pairs are further aligned in columns along the mounting face, each of the columns including multiple said signal contact pairs, the axes within each said column are aligned in a common direction, and the axes in adjacent said columns are aligned in respective different directions.

5. The electrical connector of claim 4, wherein each of the columns includes ground contacts disposed alternatively between adjacent ones of the signal contact pairs.

6. The electrical connector of claim 1 wherein a first signal contact pair includes first and second signal contacts and a second signal contact pair includes third and fourth signal contacts, the second signal contact pair being adjacent the first signal contact pair, the first signal contact being located generally the same distance from both the third and fourth signal contacts, the second signal contact being located generally the same distance from both the third and fourth signal contacts.

7. An electrical connector assembly including a pair of connectors configured to be electrically connected to one another from opposite sides of a circuit board, the electrical connector assembly comprising:
first and second connector housings, each having a mating face and a mounting face, the mounting faces being configured to be electrically connected to one another from opposite sides of the circuit board approximately in line with one another along a longitudinal axis such that the connector housings are angularly offset ninety degrees about the longitudinal axis with respect to one another; and
signal and ground contacts held in the first and second connector housings, the signal contacts being arranged in differential pairs to form signal contact pairs, the ground contacts and the signal contact pairs being aligned in a pattern of rows and columns, each of the rows including ground contacts and a first group of the signal contact pairs arranged along a row axis, adjacent rows being separated by a predetermined row pitch and having interstitial spaces located therebetween, the signal contacts further including a second group of the signal contact pairs located in the interstitial spaces between the adjacent rows and offset from the adjacent rows by a distance less than the row pitch.

8. The assembly of claim 7 wherein each of the columns includes ground contacts and the first group of the signal contact pairs arranged along a column axis, adjacent columns being separated by a predetermined column pitch and having the interstitial spaces located therebetween, the second group of the signal contact pairs being located between the adjacent columns and offset from the adjacent columns by a distance less than the column pitch.

9. The assembly of claim 7 wherein each of the rows includes a first group of the ground contacts, a second group of the ground contacts being located between adjacent rows, each of the columns including ground contacts from the second group of ground contacts.

10. The assembly of claim 7 wherein each interstitial space is defined as the space bounded by a first line extending from a first ground contact located in a first row to a second ground contact that is adjacent the first ground contact, is located between the first row and an adjacent second row, and is located within a first column, a second line extending from the second ground contact to a third ground contact that is adjacent the second ground contact and is located within the adjacent second row, a third line extending from the third ground contact to a fourth ground contact that is adjacent the first and third ground contacts, is located between the adjacent first and second rows, and is located within a second column that is adjacent the first column, and a fourth line extending from the fourth ground contact to the first ground contact.

11. The assembly of claim 7 wherein each of the second group of signal contact pairs is orientated orthogonally to each of the first group of signal contact pairs.

12. The assembly of claim 7 wherein the signal contacts of the first group of signal contact pairs within each row are arranged in a staggered pattern on opposite sides of the row axis.

13. The assembly of claim 7 wherein each of the columns includes ground contacts and the first group of the signal contact pairs arranged along a column axis, the signal contacts of the first group of signal contact pairs within each column arranged in a staggered pattern on opposite sides of the column axis.

14. The assembly of claim 7 wherein the ground contacts within each row are located on the row axis, the signal contacts of the first group of signal contact pairs within each row being arranged in a staggered pattern on opposite sides of the row axis.

15. The assembly of claim 7, wherein each of the columns includes ground contacts and the first group of the signal contact pairs arranged along a column axis, the ground contacts within each column being located on the axis, the signal contacts of the first group of signal contact pairs within each column being arranged in a staggered pattern on opposite sides of the column axis.

16. The assembly of claim 7 wherein each of the columns includes ground contacts and the first group of the signal contact pairs arranged along a column axis, each of the second group of signal contact pairs being located between adjacent row axes, each of the second group of signal contact pairs being located between adjacent column axes.

17. The assembly of claim 7 wherein each of the first group of signal contact pairs within each of the rows is separated from an adjacent signal contact pair within the row by a plurality of ground contacts.

18. The assembly of claim 7 wherein a first signal contact pair includes first and second signal contacts and a second signal contact pair includes third and fourth signal contacts, the second signal contact pair being adjacent the first signal contact pair, the first signal contact being located generally the same distance from both the third and fourth signal contacts, the second signal contact being located generally the same distance from both the third and fourth signal contacts.

19. An electrical connector comprising:
a housing that holds signal contacts which are associated as signal contact pairs, the housing having a mounting face and the signal contact pairs being aligned in rows along the mounting face, each of the rows including multiple signal contact pairs, each of the signal contact pairs including two signal contacts aligned on a respective axis; and
wherein a first signal contact pair includes first and second signal contacts and a second signal contact pair includes third and fourth signal contacts, the second signal contact pair being adjacent the first signal contact pair, the first signal contact being located generally the same distance from both the third and fourth signal contacts, the second signal contact being located generally the same distance from both the third and fourth signal contacts.

20. An electrical connector assembly including a pair of connectors configured to be electrically connected to one another from opposite sides of a circuit board, said electrical connector assembly comprising:
first and second connector housings each having a mating face and a mounting face, the mounting faces being configured to be electrically connected to one another from opposite sides of the circuit board approximately in line with one another along a longitudinal axis such that the first and second connector housings are angularly offset ninety degrees about the longitudinal axis with respect to one another; and
signal and ground contacts held in the first and second connector housings, the signal contacts being arranged in differential pairs to form a first group of signal contact pairs and a second group of signal contact pairs, the ground contacts and the first group of signal contact pairs being aligned in a first pattern of first rows and first columns, wherein the first group of signal contact pairs are arranged along first row and first column axes, adjacent first rows are separated by a predetermined first row pitch, and adjacent columns are separated by a predetermined first column pitch, the first column pitch being substantially equal to the first row pitch, and wherein the second group of signal contact pairs is arranged in a second pattern of second rows and second columns, the second group of signal contact pairs are arranged along second row and second column axes, adjacent second rows are separated by a predetermined second row pitch, and adjacent second columns are separated by a predetermined second column pitch, the second row pitch and the second column pitch of the second group of signal contact pairs being substantially equal to the first row pitch and the first column pitch, respectively, of the first group of signal contact pairs, each second row of the second group of signal contact pairs being offset from adjacent first rows of the first group of signal contact pairs by less than one first row pitch, each second column of the second group of signal contact pairs being offset from adjacent first columns of the first group of signal contact pairs by less than one first column pitch.
